(19) United States
(12) Patent Application Publication
(10) Pub. No.: US 2010/0243640 A1
(43) Pub. Date: Sep. 30, 2010

(54) COOKING DEVICE, ESPECIALLY DOMESTIC COOKING DEVICE

(75) Inventors: Bernd Buck, Windelsbach (DE); Reiner Arnold, Rottenbach (DE); Laurent Jeannatau, Compiegne (FR)

Correspondence Address: PEARNE & GORDON LLP, 1801 EAST 9TH STREET, SUITE 1200, CLEVELAND, OH, 44114-3108, US

(73) Assignee: ELECTROLUX HOME PRODUCTS CORPORATION N.V., Zaventem (BE)

(21) Appl. No.: 12/594,631

(22) PCT Filed: Mar. 6, 2008
(86) PCT No.: PCT/EP08/01785

§ 371 Date: Oct. 5, 2009

(30) Foreign Application Priority Data
Apr. 10, 2007 (EP) 07 007 313.5

(51) Int. Cl. H05B 6/12

(52) U.S. Cl. 219/622

(57) ABSTRACT

The invention relates to a cooking device, having an electrical heating element (1) arranged on a carrier element (2), wherein at least on electrical wire (3) is connected with the carrier element (2) by connection means (4, 5). To facilitate the assembly of the cooking device, the invention is characterized in that the connection means (4, 5) comprise a reception element (4) having two recesses (6, 7) forming undercuts and that the connection means (4, 5) comprise a connection member (5) with a basis structure (8) and an electrical contact (9) for engagement with the wire (3), wherein the connection member (5) has two protrusions as (10, 11) extending from the basis structure (8) of the connection member (5) and being arranged to be inserted into the recesses (6, 7).

The invention relates to a cooking device, especially to a domestic cooking device, having an electrical heating element arranged on a carrier element, wherein at least one electrical wire is connected electrically with the carrier element by connection means.

Domestic cooking devices or hobs especially of the induction heating type are well known in the art. An induction cooking unit especially for the use in home are capable of safely being used with existing metal base pans or other cooking vessels without risk of damage to the induction cooking unit. Induction cooking units are designed to inductively heat pans and other metal base cookware which are fabricated from stainless steel, iron, titanium or other similar lossy metallic materials. With regard to such induction heating units reference is made to U.S. Pat. No. 4,013,859.

Especially in induction cooking units it is common to connect a non-magnetic conductive shielding coil carrier by a coil carrier spring and possibly other intermediate means of metal being in contact with the spring with a carrier element. The intermediate metal part must be connected from high frequency points to a reference voltage from an inverter side.

The firm mechanical and electrical connection is important for a satisfying operation of the induction hob. Thus, sometimes a quite high expenditure is done to ensure a good electrical and mechanical coupling of the respective parts being necessary to form the induction heating unit.

Therefore, it is an object of the invention to improve the electrical and mechanical connection of the cooperating parts of the device and to facilitate the assembly of the device. Furthermore, maintenance services should be simplified by the suggested concept of a hob.

The solution of this object according to the invention is characterized in that the connection means comprise a reception element having at least two recesses forming undercuts respectively and that the connection means further comprise a connection member with a basis structure and with an electrical contact for engagement with the wire, wherein the connection member has at least two protrusions extending from the basis structure of the connection member and being arranged to be inserted into the recesses, wherein the protrusions are arranged resiliently relatively to the basis structure and wherein the protrusions lock into the undercuts in a mounted state of the connection means.

Preferably, the basis structure and the protrusions are made as a one-piece part. In this case the connection member can be made of a strip of sheet metal. Furthermore, at least one protrusion can be made by punching out a part of the protrusions from the strip of sheet metal and by bending the punched part away from the plane of the basis structure.

The connection member with the protrusions and the reception element can be arranged to form a cooperating snap-connection.

The protrusions have preferably a V-shaped contour. The end of the V-shaped protrusion being remote from the basis structure can be arranged to snap into the undercut formed by the recess.

The electrical contact of the connection member can be formed as a strip of material being arranged for engagement with an electrical wrap connection. In this case, the strip of material can have a substantial rectangular shape.

The recesses in the reception element have preferably a circular shape.

The reception element and the basis structure can have a substantial flat form along their contact area.

The heating element is preferably an induction coil.

With the suggested concept is becomes quite easy to firmly connect the cooperating parts electrically and mechanically. The mounting and—if necessary—the dismounting becomes quite easy. Thus the costs for producing and specifically of mounting is the hob are reduced. Only by placing the spring (connection member) at the right place the coil bottom is plan connected to the cold potential.

Furthermore a short electrical connection is ensured to improve the high frequency decoupling of the induction heating element.

The length of the wire can be kept short, whatever induction coil is used. This is of a substantial benefit because if the wire is too long the operation of the induction element is not efficient with respect to the frequency concern.

Thus, the advantageous solution is established by using a wireless connection to simplify the manipulation by mounting or servicing the induction coil. The electrical voltage reference is just connected by mechanical way to the chassis (carrier element).

In the drawings an embodiment of the invention is depicted.

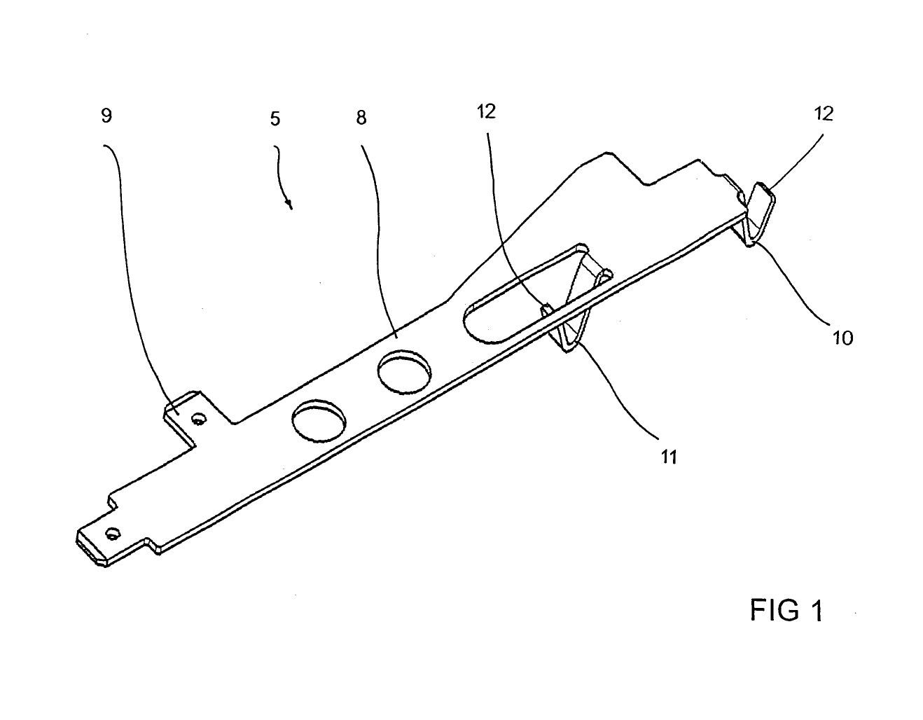

FIG. 1 shows a perspective view of a connecting member which is a part of connection means,

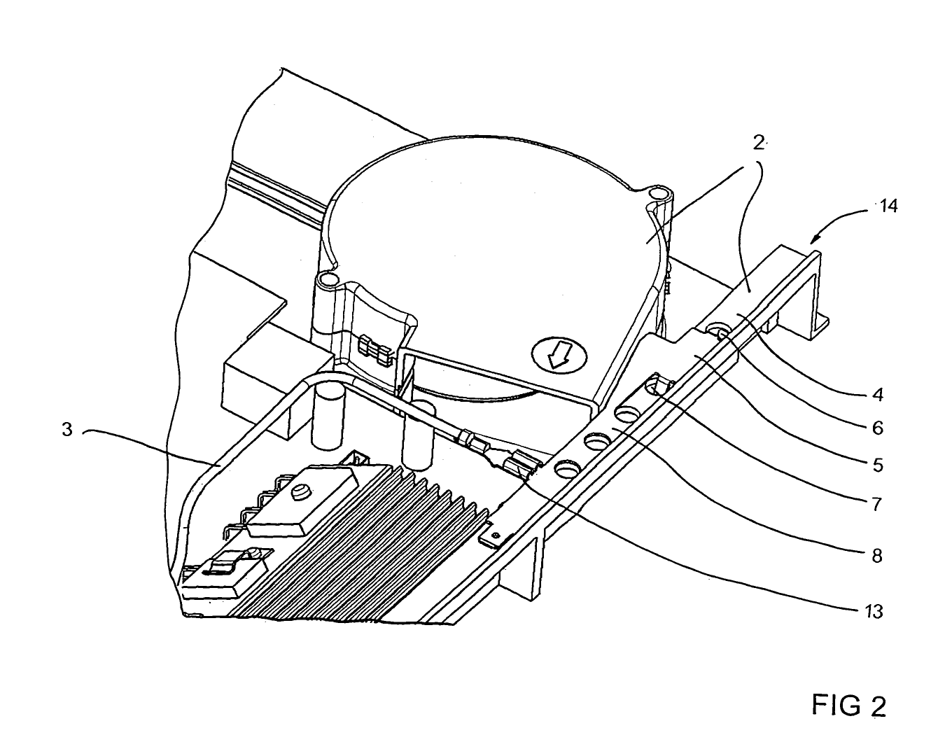

FIG. 2 shows a perspective view of a part of a domestic induction unit, wherein the heating element is not yet mounted and

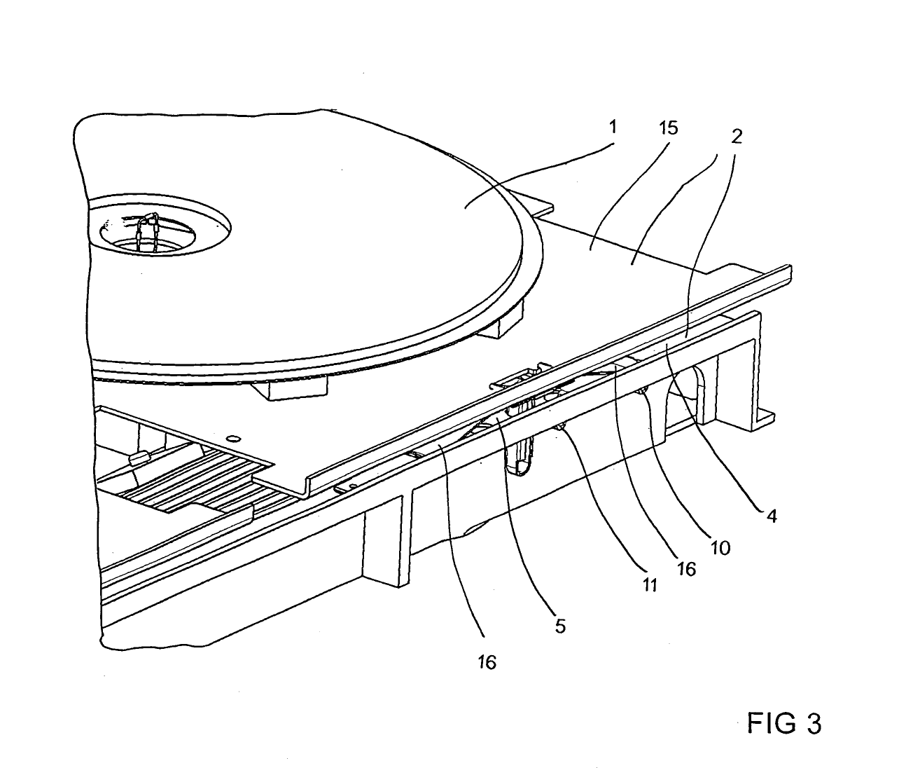

FIG. 3 shows a perspective view of the part of the domestic induction unit according to FIG. 2, wherein the heating element is mounted.

Looking at FIG. 1 and FIG. 2 a carrier element 2 is provided which bears an induction heating element 1 which is shown in FIG. 3. Parts of the carrier element 2 can be addresses as coil carrier of the induction coil 1. It is important that a firm mechanical and electrical connection is ensured for an electrical wire 3 (see FIG. 2) which is necessary to establish the electrical ground for the induction heating element 1.

To achieve a simple and thus cheap and an efficient electrical and mechanical connection between the wire 3 and the carrier element 2 the following structure is suggested:

For a firm connection of the parts connection means 4, 5 are employed. The connection means 4, 5 comprise a reception element 4 and a connection member 5. The reception element 4 has a plurality of bores (see FIG. 2) which are equidistantly arranged along a strip-shaped side 14 of the carrier element 2. The bores form recesses 6, 7 which establish undercuts, i.e. an other element can grip beyond or behind the recess to establish a snap connection.

Furthermore, the connection means 4, 5 comprise the connection member 5 (as shown in detail in FIG. 1). This connection member 5 has a flat basis structure 8 and an electrical contact 9 for engagement with the wire 3.

The connection member 5 has also two protrusions 10 and 11, which extend from the basis structure 8 of the connection member 5. The protrusions 10, 11 are arranged to be inserted into the recesses 6, 7. The protrusions 10, 11 are arranged resiliently relatively to the basis structure 8, so that they can lock into the undercuts in a mounted state of the connection means 4, 5.

The resilient arrangement of the protrusions 10, 11 is achieved in the embodiment by producing the whole connection member 5 from a strip of sheet metal.

As can be seen from FIG. 1 the protrusion 10 is formed from an end part of the connection member 5 by bending a strip-shaped part to a V-shaped structure. An end 12 of the V-shaped structure 10 snaps behind the recess 6 when the protrusion 10 is inserted into the recess 6 during assembly.

In a similar way the protrusion 11 is formed from the material of the basis structure 8 by punching out a strip-shaped part of material and by bending it to the V-shaped configuration as can be seen in FIG. 1. Also here, the end 12 of the protrusion 11 is arranged to snap behind the recess 7 when inserted during assembly.

The electrical contact between the carrier element 2 and especially the connection member 5 with the wire 3 is established by an electrical wrap connection 13 at the end of the wire 3, which cooperates with a rectangular shaped part 9 of the connection member 5 (see FIG. 1).

After assembly of the connection member 5 to the bottom part of the carrier element 2 as shown in FIG. 2, an upper part 15 of the carrier element 2 is mounted forming a coil carrier. Here some connectors 16 can be employed (see FIG. 3) to establish a mechanical and electrical connection between the different parts of the carrier elements 2.

### REFERENCE NUMERALS

1 Electrical heating element
2 Carrier element
3 Electrical wire
4, 5 Connection means
4 Reception element
5 Connection member
6 Recess
7 Recess
8 Basis structure
9 Electrical contact
10 Protrusion
11 Protrusion
12 End
13 Electrical wrap connection
14 Side
15 Upper part
16 Connector

1. Cooking device, especially domestic cooking device, having an electrical heating element (1) arranged on a carrier element (2), wherein at least one electrical wire (3) is connected electrically with the carrier element (2) by connection means (4, 5), characterized in that the connection means (4, 5) comprise a reception element (4) having at least two recesses (6, 7) forming undercuts respectively and that the connection means (4, 5) further comprise a connection member (5) with a basis structure (8) and with an electrical contact (9) for engagement with the wire (3), wherein the connection member (5) has at least two protrusions (10, 11) extending from the basis structure (8) of the connection member (5) and being arranged to be inserted into the recesses (6, 7), wherein the protrusions (10, 11) are arranged resiliently relatively to the basis structure (8) and wherein the protrusions (10, 11) lock into the undercuts in a mounted state of the connection means (4, 5).

2. Device according to claim 1, characterized in that the basis structure (8) and the protrusions (10, 11) are made as a one-piece part.

3. Device according to claim 2, characterized in that the connection member is made of a strip of sheet metal.

4. Device according to claim 3, characterized in that at least one protrusion (10, 11) is made by punching out a part of the protrusions (10, 11) from the strip of sheet metal and by bending the punched part away from the plane of the basis structure (8).

5. Device according to claim 1, characterized in that the connection member (5) with the protrusions (10, 11) and the reception element (4) are arranged to form a cooperating snap-connection.

6. Device according to claim 1, characterized in that the protrusions (10, 11) have a V-shaped contour.

7. Device according to claim 6, characterized in that the end (12) of the V-shaped protrusion (10, 11) being remote from the basis structure (8) is arranged to snap into the undercut formed by the recess (6, 7).

8. Device according to claim 1, characterized in that the electrical contact (9) of the connection member (5) is formed as a strip of material being arranged for engagement with an electrical wrap connection (13).

9. Device according to claim 8, characterized in that the strip of material (9) has a substantial rectangular shape.

10. Device according to claim 1, characterized in that the recesses (6, 7) in the reception element (4) have a circular shape.

11. Device according to claim 1, characterized in that the reception element (4) and the basis structure (8) have a substantial flat form along their contact area.

12. Device according to claim 1, characterized in that the heating element (1) is an induction coil.
